(19) United States
(12) Patent Application Publication
(10) Pub. No.: US 2022/0343240 A1
(43) Pub. Date: Oct. 27, 2022

(54) SYSTEM AND METHOD FOR PARALLEL OBJECT MODIFICATION IN AN ENTERPRISE RESOURCE PLANNING APPLICATION

(71) Applicant: MARLABS INNOVATIONS PRIVATE LIMITED, BANGALORE (IN)

(72) Inventors: RAVI KUMAR VENKATA RANGA GARRE, BANGALORE (IN); KIRAN MANNUMKATTIL VISWAMBHARAN, TRIVANDRUM (IN)

(21) Appl. No.: 17/356,729

(22) Filed: Jun. 24, 2021

(30) Foreign Application Priority Data
Apr. 27, 2021 (IN) 202141019208

(51) Int. Cl. G06Q 10/06; G06Q 10/10

(52) U.S. Cl. CPC G06Q 10/06313; G06Q 10/067; G06Q 10/063118; G06Q 10/103; H04L 67/10

(57) ABSTRACT

A system for parallel object modification is disclosed. A request receiving module receives a processing request released from a first project executed at a first project wave landscape of the enterprise resource planning application. A parallel processing module instantiates one or more objects for parallel execution at a second project wave landscape. An object modification determination module detects one or more scenarios of modification of the one or more objects corresponding to the first project wave landscape and the second project wave landscape respectively, wherein the one or more scenarios includes a conflict scenario, a semi-computerized scenario and a non-conflict scenario. An object lock solution manager identifies one or more conflicted objects and one or more corresponding dependencies at the first project wave and the second project wave respectively, enables a taskforce in retrofitting of one or more modifications for attaining synchronization between the first project wave landscape and the second project wave landscape respectively.

### CROSS-REFERENCE TO RELATED APPLICATION

This Application claims priority from a complete patent application filed in India having Patent Application No. 202141019208, filed on Apr. 27, 2021 and titled “SYSTEM AND METHOD FOR PARALLEL OBJECT MODIFICATION IN AN ENTERPRISE RESOURCE PLANNING APPLICATION”

### BACKGROUND

Embodiments of the present disclosure relate to a parallel development of applications and more particularly to a system and a method for parallel object modification in an enterprise resource planning application.

Enterprise resource planning (ERP) refers to a type of software that organizations use to manage day-to-day business activities such as accounting, procurement, project management, risk management and compliance, and supply chain operations. A complete ERP suite also includes enterprise performance management, software that helps plan, budget, predict, and report on an organization' financial results. The ERP systems tie together a multitude of business processes and enable the integrated flow of data between them. By collecting an organization's shared transactional data from multiple sources, the ERP systems eliminate data duplication and provide data integrity with a single source of truth. Generally, in case of the implementation of ERP systems for multiple legal entities & business processes in parallel, object locking concept is a major problem which remains unresolved as of today. Various systems are available which focuses on resolution of the object locking in the ERP systems and mandated to execute one or more business projects accordingly.

Conventionally the ERP systems which are available during execution of the one or more business projects generally opens an object for modification for a developer and locks for other developers to work on it simultaneously. However, such a conventional system focusses on the concept of object locking which results in delayed completion of the one or more business projects scheduled in parallel. Also, the object locking has multi-dimensional impact as it significantly delays an enterprise's IT roadmap, dilution of expected ROI and time to value, unpleasant user experience. Moreover, such a conventional system in case of the object locking has cost impact due to resource idling since developers go for wait status until objects are unlocked.

Hence, there is a need for an improved system and a method for parallel object modification in an enterprise resource planning application in order to address the aforementioned issues.

### BRIEF DESCRIPTION

In accordance with an embodiment of the present disclosure, a system for parallel object modification in an enterprise resource planning application is disclosed. The system includes a processing subsystem hosted on a server and configured to execute on a network to control bidirectional communications among a plurality of modules. The processing subsystem includes a request receiving module configured to receive a processing request released from a first project executed at a first project wave landscape of the enterprise resource planning application. The system also includes a cross system solution manager which is located on another processing subsystem hosted on another server in a distributed environment. The cross-system solution manager includes a parallel processing module operatively coupled to the request receiving module. The parallel processing module is configured to instantiate one or more objects for parallel execution at a second project wave landscape based on the processing request received from the first project wave landscape. The cross-system solution manager also includes an object modification determination module operatively coupled to the parallel processing module, wherein the object modification module is configured to detect one or more scenarios of modification of the one or more objects corresponding to the first project wave landscape and the second project wave landscape respectively, wherein the one or more scenarios comprises a conflict scenario, a semi-computerized scenario and a non-conflict scenario. The cross-system solution manager also includes an object lock solution manager operatively coupled to the object modification module and the parallel processing module, wherein the object lock solution manager is configured to identify one or more conflicted objects and one or more corresponding dependencies at the first project wave and the second project wave respectively when the conflict scenario and the semi-computerized scenario are detected. The object lock solution manager is also configured to enable a taskforce in retrofitting of one or more modifications for attaining synchronization between the first project wave landscape and the second project wave landscape respectively based on the one or more conflicted objects and the one or more corresponding dependencies identified. The cross-system solution manager also includes a notification generation module operatively coupled to the object solution manager, wherein the notification generation module is configured to notify the taskforce to perform the retrofitting of the one or more modifications corresponding to a predefined project schedule for addressing cross project wave object locks via a notification means.

In accordance with another embodiment of the present disclosure, a method for parallel object modification in an enterprise resource planning application is disclosed. The method includes receiving, by a request receiving module, a processing request released from a first project executed at a first project wave landscape of the enterprise resource planning application. The method also includes instantiating, by a parallel processing module, one or more objects for parallel execution at a second project wave landscape based on the processing request received from the first project wave landscape. The method also includes detecting, by an object modification determination module, one or more scenarios of modification of the one or more objects corresponding to the first project wave landscape and the second project wave landscape respectively, wherein the one or more scenarios comprises a conflict scenario, a semi-computerized scenario and a non-conflict scenario. The method also includes identifying, by an object lock solution manager, one or more conflicted objects and one or more corresponding dependencies at the first project wave and the second project wave respectively when the conflict scenario and the semi-computerized scenario are detected. The method also includes enabling, by the object lock solution manager, a taskforce in retrofitting of one or more modifications for attaining synchronization between the first project wave landscape and the second project wave landscape respectively based on the one or more conflicted objects and the one or more corresponding dependencies identified. The method also includes notifying, by a notification generation module, the taskforce to perform the retrofitting of the one or more modifications corresponding to a predefined project schedule for addressing cross project wave object locks via a notification means.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for parallel object modification in an enterprise resource planning application in accordance with an embodiment of the present disclosure;

FIG. 2 is a block diagram representation of an embodiment of a system for parallel object modification in an enterprise resource planning application of FIG. 1 in accordance with an embodiment of the present disclosure;

FIG. 3 illustrates a schematic representation of an exemplary embodiment of a system for parallel object modification in an enterprise resource planning application of FIG. 1 in accordance with an embodiment of the present disclosure:

FIG. 4 is a block diagram of a computer or a server in accordance with an embodiment of the present disclosure; and

FIG. 5 is a flow chart representing the steps involved in a method for parallel object modification in an enterprise resource planning application of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”. “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for parallel object modification in an enterprise resource planning application. The system includes a processing subsystem hosted on a server and configured to execute on a network to control bidirectional communications among a plurality of modules. The processing subsystem includes a request receiving module configured to receive a processing request released from a first project executed at a first project wave landscape of the enterprise resource planning application. The system also includes a cross system solution manager which is located on another processing subsystem hosted on another server in a distributed environment. The cross-system solution manager includes a parallel processing module is configured to instantiate one or more objects for parallel execution at a second project wave landscape based on the processing request received from the first project wave landscape. The cross system solution manager also includes an object modification determination module operatively coupled to the parallel processing module, wherein the object modification module is configured to detect one or more scenarios of modification of the one or more objects corresponding to the first project wave landscape and the second project wave landscape respectively, wherein the one or more scenarios comprises a conflict scenario, a semi-computerized scenario and a non-conflict scenario. The cross-system solution manager also includes an object lock solution manager operatively coupled to the object modification module and the parallel processing module, wherein the object lock solution manager is configured to identify one or more conflicted objects and one or more corresponding dependencies at the first project wave and the second project wave respectively when the conflict scenario and the semi-computerized scenario are detected. The object lock solution manager is also configured to enable a taskforce in retrofitting of one or more modifications for attaining synchronization between the first project wave landscape and the second project wave landscape respectively based on the one or more conflicted objects and the one or more corresponding dependencies identified. The cross-system solution manager also includes a notification generation module operatively coupled to the object solution manager, wherein the notification generation module is configured to notify the taskforce to perform the retrofitting of the one or more modifications corresponding to a predefined project schedule for addressing cross project wave object locks via a notification means.

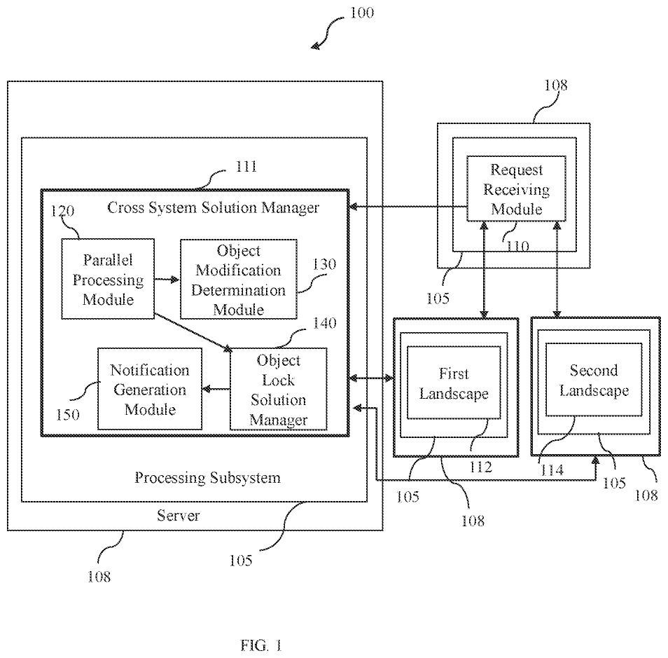

FIG. 1 is a block diagram of a system 100 for parallel object modification in an enterprise resource planning application in accordance with an embodiment of the present disclosure. The system 100 includes a processing subsystem 105 hosted on a server 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes a request receiving module 110 configured to receive a processing request released from a first project executed at a first project wave landscape of the enterprise resource planning application. As used herein, the term ‘first project’ is defined as a logically independent enterprise project which is executed on a project execution landscape of an enterprise resource planning (ERP) application. In one embodiment, the first project landscape may include a primary project wave landscape for project execution of a plurality of enterprise resource projects.

The system 100 also includes a cross system solution manager 111 which is located on another processing subsystem 105 hosted on another server 108 in a distributed environment. The cross-system solution manager 111 includes a parallel processing module 120 operatively coupled to the request receiving module 110. The parallel processing module 120 is configured to instantiate one or more objects for parallel execution at a second project wave landscape based on the processing request received from the first project wave landscape. As used herein, the term ‘objects’ is defined as a special kind of variable that has distinct characteristics and behaviours. In one embodiment, the object may include, but not limited to, a report, a form, an interface and the like. In one embodiment, the second project wave landscape includes a project wave with a second set of development and quality assurance structure to develop, configure or adjust a similar object corresponding to the primary landscape.

The cross-system solution manager 111 also includes an object modification determination module 130 operatively coupled to the parallel processing module 120. The object modification module 130 is configured to detect one or more scenarios of modification of the one or more objects corresponding to the first project wave landscape and the second project wave landscape respectively, wherein the one or more scenarios includes a conflict scenario, a semi-computerized scenario and a non-conflict scenario. As used herein, the term ‘conflict scenario’ is defined as one or more conflicts which arises due to modification of objects at both landscapes. Similarly, the term ‘semi-computerized scenario’ is defined as both manual and automated synchronization required for modification in another landscape due to change of objects in one landscape alone. Again, the term ‘non-conflict scenario’ is defined as a situation in which object at one landscape alone changed and easy and fully automated synchronization between both the landscape is possible.

In a specific embodiment, the non-conflict scenario may include synchronization of the object in the first project wave and the second project wave respectively with an indication of a first status. In such embodiment, the first status may include a green colour status. In one embodiment, the semi-computerized scenario includes checking a manual synchronization or an automated synchronization executable for the one or more conflicted objects identified by using a workbench set or a business configuration set of the enterprise resource planning application. In such embodiment, the semi-computerized scenario is indicated by a second status such as an amber colour status. In another embodiment, the conflict scenario is indicated by a third status. In such embodiment, the third status may include a red colour status.

The cross-system solution manager 111 also includes an object lock solution manager 140 operatively coupled to the object modification module 130 and the parallel processing module 120. The object lock solution manager 140 is configured to identify one or more conflicted objects and one or more corresponding dependencies at the first project wave and the second project wave respectively when the conflict scenario and the semi-computerized scenario are detected. The object lock solution manager 140 is configured to track of the one or more modifications or configurations associated with the first project wave and the second project wave respectively.

The object lock solution manager 140 is also configured to enable a taskforce in retrofitting of one or more modifications for attaining synchronization between the first project wave landscape and the second project wave landscape respectively based on the one or more conflicted objects and the one or more corresponding dependencies identified. In a particular embodiment, the taskforce may include a team including a technical, functional and a change advisory board to perform retrofitting of the one or more modifications for attaining synchronization when the one or more conflicted objects are identified in the first project wave and second project wave.

The cross-system solution manager 111 also includes a notification generation module 150 operatively coupled to the object lock solution manager 140. The notification generation module 150 is configured to notify the taskforce to perform the retrofitting of the one or more modifications corresponding to a predefined project schedule for addressing cross project wave object locks via a notification means. In one embodiment, the notification means may include, but not limited to an email.

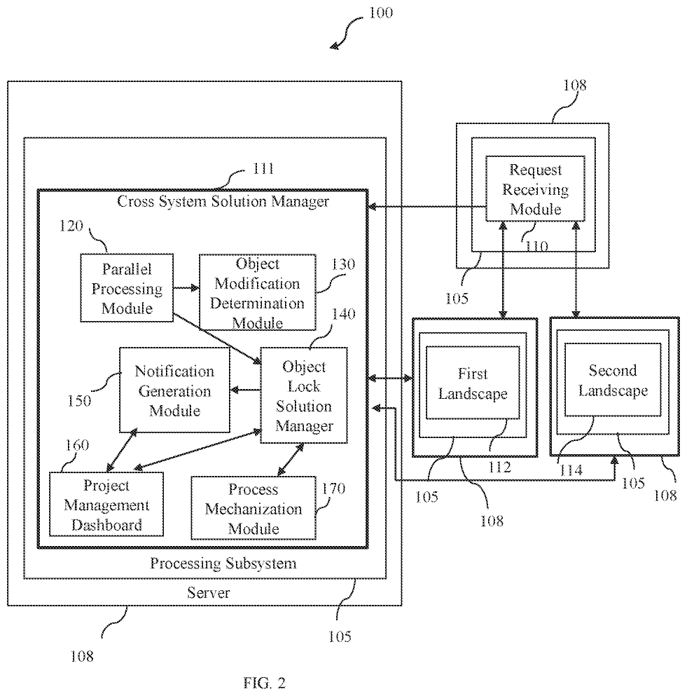

FIG. 2 is a block diagram representation of an embodiment of a system for parallel object modification in an enterprise resource planning application of FIG. 1 in accordance with an embodiment of the present disclosure. As described in aforementioned FIG. 1, the system 100 includes a processing subsystem 105, which includes a request receiving module 110. The system 100 also includes another processing subsystem 105 which is hosted on a remote server 108 in a distributed environment. In such a server, the processing subsystem 105 includes a cross system solution manager 111 which includes a parallel processing module 120, an object modification module 130, an object lock solution manager 140 and a notification generation module 150. In addition, the cross-system solution manager 111 also includes a project management dashboard 160 configured to represent statistics of at least one of a number of the one or more objects locking scenarios addressed, a number of the one or more objects locking scenarios unaddressed, work in progress, time saved, effort saved, cost saved, plan for one or more enterprise resource planning projects. The cross-system solution manager 111 also includes a process mechanization module 170 configured to execute one or more short-listed activities representative of retrofitting the one or more modifications assigned to the task force for attaining synchronization.

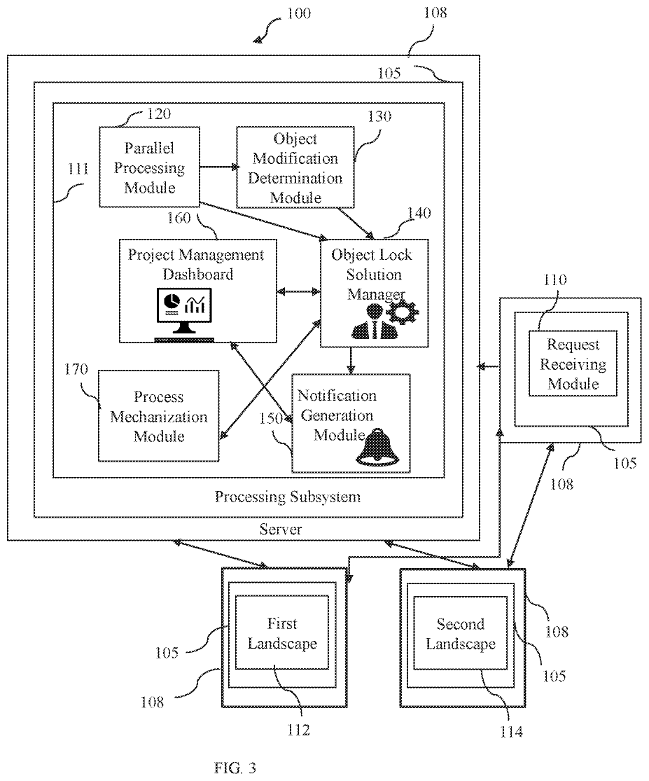

FIG. 3 illustrates a schematic representation of an exemplary embodiment of a system for parallel object modification in an enterprise resource planning application of FIG. 1 in accordance with an embodiment of the present disclosure. Considering an example, where a business project ‘X’ is being executed in a first project wave landscape of an enterprise resource planning (ERP) application. The project ‘X’ is executed in a parallel manner using one or more project wave landscapes. Let us assume that the project ‘X’ is executed in the first project wave landscape and a second project wave landscape of the ERP application. In the example used herein, the first project landscape may include a primary project wave landscape for project execution. Again, the second project wave landscape includes a project wave with a second set of development and quality assurance structure to develop, configure or adjust a similar object corresponding to the primary landscape.

For initiating project execution, the processing subsystem 105 includes a request receiving module 110 to receive a processing request released from the business project executed at the first project wave landscape of the ERP application. Here, the processing subsystem is hosted on a cloud server 108. The processing subsystem 105 is configured to execute on a network to control bidirectional communications among a plurality of modules. For example, the network may include a wireless communication network. Once, the processing request is received, a parallel processing module 120 of a cross system solution manager 111 which is located on a processing subsystem of another server in a distributed environment, instantiates one or more objects for parallel execution at the second project wave landscape. For example, the object may include but not limited to, a report, a form, an interface and the like.

The cross-system solution manager 111 also includes an object modification module 130 to detect one or more scenarios of modification of the one or more objects corresponding to the first project wave landscape and the second project wave landscape respectively, wherein the one or more scenarios includes a conflict scenario, a semi-computerized scenario and a non-conflict scenario. In the example used herein, the non-conflict scenario may include synchronization of the object in the first project wave and the second project wave respectively with an indication of a first status. For example, the first status may include a green colour status. Similarly, the semi-computerized scenario includes checking a manual synchronization or an automated synchronization executable for the one or more conflicted objects identified by using a workbench set or a business configuration set of the enterprise resource planning application. In such an example, the semi-computerized scenario is indicated by a second status such as an amber colour status. Again, the conflict scenario is indicated by a third status. For example, the third status may include a red colour status.

The cross-system solution manager 111 also includes an object lock solution manager 140 operatively coupled to the object modification module 130 and the parallel processing module 120. The object lock solution manager 140 identifies one or more conflicted objects and one or more corresponding dependencies at the first project wave and the second project wave respectively when the conflict scenario and the semi-computerized scenario are detected. The object lock solution manager 140 also tracks the one or more modifications or configurations associated with the first project wave and the second project wave respectively. Not only this, the object lock solution manager 140 also enables a taskforce in retrofitting one or more modifications for attaining synchronization between the first project wave landscape and the second project wave landscape respectively based on the one or more conflicted objects and the one or more corresponding dependencies identified. For example, the taskforce may include a team including a technical, functional and a change advisory board to perform retrofitting of the one or more modifications for attaining synchronization when the one or more conflicted objects are identified in the first project wave and second project wave.

Further, for providing notifications in real-time to the taskforce in case of conflicts, a notification generation module 150 notifies the taskforce to perform the retrofitting of the one or more modifications corresponding to a predefined project schedule for addressing cross project wave object locks via a notification means. For example, the notification means may include, but not limited to an email.

In addition, the cross-system solution manager 111 also includes a project management dashboard 160 configured to represent statistics of at least one of a number of the one or more objects locking scenarios addressed, a number of the one or more objects locking scenarios unaddressed, work in progress, time saved, effort saved, cost saved, plan for one or more enterprise resource planning projects. Moreover, the cross-system solution manager 111 also includes a process mechanization module 170 to execute one or more short-listed activities representative of retrofitting the one or more modifications assigned to the task force for attaining synchronization. Thus, intelligent robotic process automation to automate short-listed activities are assigned to the task force for retrofitting the one or more modifications for attaining synchronization and solving the problem of object locks.

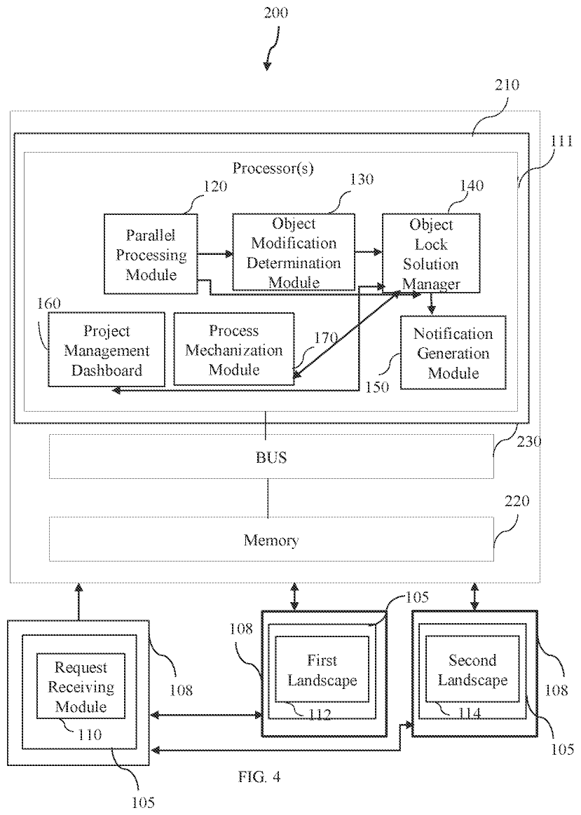

FIG. 4 is a block diagram of a computer or a server in accordance with an embodiment of the present disclosure. The server 200 includes processor(s) 230, and memory 210 operatively coupled to the bus 220. Here multiple servers in distributed environment is shown. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has a request receiving module 110. The processing subsystem of another server in the distributed environment further includes a cross system solution manager 111 which includes a parallel processing module 120, an object modification determination module 130, an object lock solution manager 140, and a notification generation module 150, a project management dashboard 160 and a process mechanization module 170.

The request receiving module 110 configured to receive a processing request released from a first project executed at a first project wave landscape of the enterprise resource planning application. The parallel processing module 120 configured to instantiate one or more objects for parallel execution at a second project wave landscape based on the processing request received from the first project wave landscape. The object modification determination module 130 configured to detect one or more scenarios of modification of the one or more objects corresponding to the first project wave landscape and the second project wave landscape respectively, wherein the one or more scenarios comprises a conflict scenario, a semi-computerized scenario and a non-conflict scenario. The object lock solution manager 140 configured to identify one or more conflicted objects and one or more corresponding dependencies at the first project wave and the second project wave respectively when the conflict scenario and the semi-computerized scenario are detected. The object lock solution manager 140 is also configured to enable a taskforce in retrofitting of one or more modifications for attaining synchronization between the first project wave landscape and the second project wave landscape respectively based on the one or more conflicted objects and the one or more corresponding dependencies identified. The notification generation module 150 is configured to notify the taskforce to perform the retrofitting of the one or more modifications corresponding to a predefined project schedule for addressing cross project wave object locks via a notification means. The processing subsystem 105 also includes a project management dashboard 160 configured to represent statistics of at least one of a number of the one or more objects locking scenarios addressed, a number of the one or more objects locking scenarios unaddressed, work in progress, time saved, effort saved, cost saved, plan for one or more enterprise resource planning projects. The processing subsystem 105 also includes a process mechanization module 170 configured to execute one or more short-listed activities representative of retrofitting the one or more modifications assigned to the task force for attaining synchronization.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

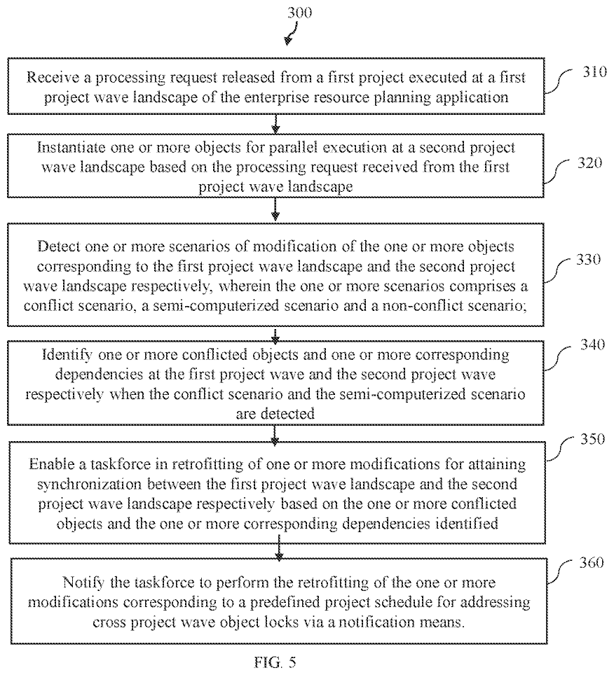

FIG. 5 is a flow chart representing the steps involved in a method 300 for parallel object modification in an enterprise resource planning application of FIG. 1 in accordance with the embodiment of the present disclosure. The method 300 includes receiving, by a request receiving module, a processing request released from a first project executed at a first project wave landscape of the enterprise resource planning application in step 310. In one embodiment, receiving the processing request released from the first project executed at the first project wave landscape may include receiving the processing request for a primary project wave landscape for project execution of a plurality of enterprise resource projects.

The method 300 also includes instantiating, by a parallel processing module, one or more objects for parallel execution at a second project wave landscape based on the processing request received from the first project wave landscape in step 320. In one embodiment, instantiating the one or more objects for the parallel execution at the second project wave landscape may include instantiating the one or more objects which may include, but not limited to, a report, a form, an interface and the like. In one embodiment, the second project wave landscape includes a project wave with a second set of development and quality assurance structure to develop, configure or adjust a similar object corresponding to the primary landscape.

The method 300 also includes detecting, by an object modification determination module, one or more scenarios of modification of the one or more objects corresponding to the first project wave landscape and the second project wave landscape respectively, wherein the one or more scenarios includes a conflict scenario, a semi-computerized scenario and a non-conflict scenario in step 330. In one embodiment, detecting the non-conflict scenario may include determining synchronization of the object in the first project wave and the second project wave respectively with an indication of a first status. In such embodiment, the first status may include a green colour status. In another embodiment, detecting the semi-computerized scenario may include checking a manual synchronization or an automated synchronization executable for the one or more conflicted objects identified by using a workbench set or a business configuration set of the enterprise resource planning application. In such embodiment, the semi-computerized scenario is indicated by a second status such as an amber colour status. In another embodiment, the conflict scenario is indicated by a third status. In such embodiment, the third status may include a red colour status.

The method 300 also includes identifying, by an object lock solution manager, one or more conflicted objects and one or more corresponding dependencies at the first project wave and the second project wave respectively when the conflict scenario and the semi-computerized scenario are detected in step 340. The method 300 also includes enabling, by the object lock solution manager, a taskforce in retrofitting of one or more modifications for attaining synchronization between the first project wave landscape and the second project wave landscape respectively based on the one or more conflicted objects and the one or more corresponding dependencies identified in step 350.

The method 300 also includes notifying, by a notification generation module, the taskforce to perform the retrofitting of the one or more modifications corresponding to a predefined project schedule for addressing cross project wave object locks via a notification means in step 360. In one embodiment, notifying the taskforce to perform the retrofitting of the one or more modifications may include notifying the taskforce which may include a team including a technical, functional and a change advisory board. In such embodiment, notifying the taskforce to perform the retrofitting of the one or more modifications may include notifying the taskforce via a notification email.

Various embodiments of the present disclosure provides a technical solution that address the native challenge of object locking during parallel execution of the one or more business projects executed within same landscape of an enterprise resource planning application.

Moreover, the present disclosed system helps enterprise customers to see accelerated solution delivery and thus offering quick time to value and significantly improves user experience.

Furthermore, the present disclosed system works with the concept of bi-directional retrofit using parallel project wave landscape that addresses all possible object locks during execution of parallel processing. Also, the present disclosed system provides a cost-effective solution for handling the problem of object locks which further benefits the enterprises.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for parallel object modification in an enterprise resource planning application, comprising:
a processing subsystem hosted on a server and configured to execute on a network to control bidirectional communications among a plurality of modules comprising:
a request receiving module configured to receive a processing request released from a first project executed at a first project wave landscape of the enterprise resource planning application;
a cross-system solution manager comprising:
a parallel processing module operatively coupled to the request receiving module, wherein the parallel processing module is configured to instantiate one or more objects for parallel execution at a second project wave landscape based on the processing request received from the first project wave landscape;
an object modification determination module operatively coupled to the parallel processing module, wherein the object modification module is configured to detect one or more scenarios of modification of the one or more objects corresponding to the first project wave landscape and the second project wave landscape respectively, wherein the one or more scenarios comprises a conflict scenario, a semi-computerized scenario and a non-conflict scenario;
an object lock solution manager operatively coupled to the object modification determination module and the parallel processing module, wherein the object lock solution manager is configured to:
identify one or more conflicted objects and one or more corresponding dependencies at the first project wave and the second project wave respectively when the conflict scenario and the semi-computerized scenario are detected; and
enable a taskforce in retrofitting of one or more modifications for attaining synchronization between the first project wave landscape and the second project wave landscape respectively based on the one or more conflicted objects and the one or more corresponding dependencies identified; and
a notification generation module operatively coupled to the object lock solution manager, wherein the notification generation module is configured to notify the taskforce to perform the retrofitting of the one or more modifications corresponding to a predefined project schedule for addressing cross project wave object locks via a notification means.

2. The system as claimed in claim 1, wherein the first project wave landscape comprises a primary project wave landscape for project execution of a plurality of enterprise resource projects.

3. The system as claimed in claim 1, wherein the second project wave landscape comprises a project wave with a second set of development and quality assurance structure to develop, configure or adjust a similar object corresponding to the primary landscape.

4. The system as claimed in claim 1, wherein the non-conflict scenario comprises synchronization of the object in the first project wave and the second project wave respectively with an indication of a first status.

5. The system as claimed in claim 1, wherein the semi-computerized scenario comprises checking a manual synchronization or an automated synchronization executable for the one or more conflicted objects identified by using a workbench set or a business configuration set of the enterprise resource planning application.

6. The system as claimed in claim 5, wherein the semi-computerized scenario is indicated by a second status.

7. The system as claimed in claim 1, wherein the conflict scenario is indicated by a third status.

8. The system as claimed in claim 1, wherein the object lock solution manager is configured to track of the one or more modifications or configurations associated with the first project wave and the second project wave respectively.

9. The system as claimed in claim 1, wherein the taskforce comprises a team comprising a technical, functional and a change advisory board to perform retrofitting of the one or more modifications for attaining synchronization when the one or more conflicted objects are identified in the first project wave and second project wave.

10. The system as claimed in claim 1, wherein the cross-system solution manager comprising a project management dashboard configured to represent statistics of at least one of a number of the one or more objects locking scenarios addressed, a number of the one or more objects locking scenarios unaddressed, work in progress, time saved, effort saved, cost saved, plan for one or more enterprise resource planning projects.

11. The system as claimed in claim 1, wherein the cross-system solution manager comprising a process mechanization module configured to execute one or more short-listed activities representative of retrofitting the one or more modifications assigned to the task force for attaining synchronization.

12. A method comprising:
receiving, by a request receiving module, a processing request released from a first project executed at a first project wave landscape of the enterprise resource planning application;
instantiating, by a parallel processing module, one or more objects for parallel execution at a second project wave landscape based on the processing request received from the first project wave landscape;
detecting, by an object modification determination module, one or more scenarios of modification of the one or more objects corresponding to the first project wave landscape and the second project wave landscape respectively, wherein the one or more scenarios comprises a conflict scenario, a semi-computerized scenario and a non-conflict scenario;
identifying, by an object lock solution manager, one or more conflicted objects and one or more corresponding dependencies at the first project wave and the second project wave respectively when the conflict scenario and the semi-computerized scenario are detected;
enabling, by the object lock solution manager, a taskforce in retrofitting of one or more modifications for attaining synchronization between the first project wave landscape and the second project wave landscape respectively based on the one or more conflicted objects and the one or more corresponding dependencies identified; and
notifying, by a notification generation module, the taskforce to perform the retrofitting of the one or more modifications corresponding to a predefined project schedule for addressing cross project wave object locks via a notification means.
